(19) United States
(12) Patent Application Publication
(10) Pub. No.: US 2025/0180416 A1
(43) Pub. Date: Jun. 5, 2025

(54) MULTIMODAL MECHANICAL SENSING WITH DEFORMABLE LIQUID METAL TRANSMISSION LINES

(71) Applicant: Trustees of Dartmouth College, Hanover, NH (US)

(72) Inventors: William SCHEIDELER, West Lebanon, NH (US); Md Saifur RAHMAN, Hanover, NH (US)

(21) Appl. No.: 18/842,975

(22) PCT Filed: Mar. 6, 2023
(86) PCT No.: PCT/US2023/014659

§ 371 Date: Aug. 30, 2024

Related U.S. Application Data
(60) Provisional application No. 63/316,587, filed on Mar. 4, 2022.

(51) Int. Cl. G01L 1/22

(52) U.S. Cl. CPC G01L 1/225

(57) ABSTRACT

AC-based resistive sensing can be performed on a liquid metal sensor that includes at least one trace. For example, measurements of geometrical modulation of an AC skin effect in a trace of a liquid metal sensor can be used during sensing. DC-based resistive sensing can be used with the AC-based resistive sensing.

### CROSS-REFERENCE TO RELATED APPLICATIONS

This application claims priority to the provisional patent application filed Mar. 4, 2022 and assigned U.S. App. No. 63/316,587, the disclosure of which is hereby incorporated by reference.

### FIELD OF THE DISCLOSURE

This disclosure relates to mechanical sensors.

### BACKGROUND OF THE DISCLOSURE

Stretchable electronics are well-suited for the complex geometries and compliant mechanics of the human body. This can allow stretchable and flexible devices to target various on-body biomedical sensing applications such as pulse wave sensing, oximetry, and bio-impedance tomography due to their multidirectional stretchability and deformability. In addition, conformal contact provided by stretchable materials can enhance signal quality by reducing motion artifacts and transforming wearable electronics into a lightweight and unobtrusive devices that are virtually imperceptible. Liquid metals such as eGaIn and Galinstan are the highest performance materials available for stretchable electronic interconnects due to their high electrical conductivity (3.4*10⁶ S/m) and low toxicity. This easily accommodates the cyclic loads of large uniaxial and biaxial strain required for wearable devices without requiring serpentine patterning.

The reliability and performance of liquid metal conductors are important to stretchable wireless circuits that integrate many passive components, sensors, and integrated circuits. These wearable systems will encounter deformation during regular use that may include a biaxial strain of up to 30-40% in the skin at joints such as the knuckles or elbow. Sustaining these mechanical deformations also allows resistive sensing modalities to turn liquid metal traces into strain gauges. The deformation of liquid metal conductors can include modes such as mechanical stretching, torsion, or compression. The electrical response of liquid metal conductors to many of these modes of mechanical deformation can be predicted based on the degree of strain, the cross-sectional geometry, and the length.

Modulation of AC resistance represents a new modality that can expand the sensitivity and capabilities of liquid metal stretchable sensors by fully leveraging the physics of their deformable liquid geometries. AC-based liquid metal sensing previously utilized reflections in the transmission lines, changes in inductance, or changes in capacitance. However, these previous techniques did not appreciate that the deformable geometry naturally modifies their electromagnetics at the microscale.

Improved systems and methods are needed.

### BRIEF SUMMARY OF THE DISCLOSURE

A system is provided in a first embodiment. The system includes a liquid metal sensor including at least one trace and a processor in electronic communication with the liquid metal sensor. The processor is configured to perform AC-based resistive sensing of the liquid metal sensor.

The processor can be configured to measure geometrical modulation of an AC skin effect in the trace of the liquid metal sensor. Current flow may be predominantly confined to a surface of the trace.

The processor can be further configured to perform DC-based resistive sensing.

The processor can be configured to detect tensile strain oriented axially along a direction of current conduction.

The processor can be configured to detect compressive strain applied out of a plane of current conduction.

The trace can have a diameter from 1 μm to 10 cm.

The liquid metal sensor can include a gallium-indium alloy, InGaSn, an alloy of gallium, indium, and bismuth, or an alloy of gallium, indium, and cadmium.

The at least one trace may be part of a network of liquid metal traces.

The trace can include parallel strands woven together.

A method is provided in a second embodiment. The method includes receiving measurements of geometrical modulation of an AC skin effect in a trace of a liquid metal sensor. AC-based resistive sensing is performed on the measurements using a processor.

Current flow may be predominantly confined to a surface of the trace.

The method can further include performing DC-based resistive sensing using the processor. This can involve determining a mode and a degree of deformation of the trace.

The method can further include detecting tensile strain oriented axially along a direction of current conduction using the processor.

The method can further include detecting compressive strain applied out of a plane of current conduction using the processor.

A non-transitory computer readable medium storing a program can be configured to instruct a processor to execute the method of the second embodiment.

### DESCRIPTION OF THE DRAWINGS

For a fuller understanding of the nature and objects of the disclosure, reference should be made to the following detailed description taken in conjunction with the accompanying drawings, in which:

FIG. 1(a) are current density maps illustrating bulk versus surface current crowding for lower frequency (100 kHz) (left), medium frequency (1 MHz) (middle), and higher frequency (100 MHz) signals (right);

FIG. 1(b) shows the simulated AC resistance per length of liquid metal conductors of varying diameter as a function of frequency, indicating the positive power law scaling with frequency;

FIG. 1(c) shows the simulated AC resistance of circular, square, and rectangular cross-section conductors as a function of their perimeter to area ratio at low (10 Hz), medium (1 MHz), and high frequencies (100 MHz) with an inset showing current density maps for circular, square, and rectangular conductor cross-sectional geometries;

FIG. 1(d) shows an example of a flexible integrated circuit consisting of passive electromagnetic structures such as a spiral inductor made from liquid metal;

FIG. 2(a) are finite element analysis (FEA) simulations showing current density for stretching (i) and compression (ii) of a liquid metal sensor at 10 MHz with a 0.5 mm diameter, wherein the largest J value is proximate to the exterior and the smallest J value is proximate the center;

FIG. 2(b) are simulated AC resistance per cm for a 0.5 mm diameter as a function of both compressive and stretching strain for 10 Hz, 10 MHz, and 40 MHz FIG. 2(c) shows a mapping of R_{ac} and R_{dc} per cm for progressively higher degrees of compression and stretching at different frequencies (10 Hz, 10 MHz, 40 MHz);

FIG. 3(a) shows the fabrication scheme used to assemble the high frequency liquid metal sensors;

FIG. 3(b) shows compression and stretching zones located at the location of fingertips and knuckle joints in a liquid metal RF sensor-based gesture tracking glove;

FIGS. 3(c) and 3(d) show pictures of the quantitative measurement of stretching (c) and compression (d) via gesture tracking gloves incorporating the liquid metal sensors;

FIGS. 3(e) and 3(f) show resistance versus time for dynamic cycles of stretching (e) and compression (f) in response to flexion of the knuckle joint angle (45°) and digital pinching force (˜20 N) at low (40 Hz) and high-frequency (40 MHz);

FIG. 3(g) shows the AC resistance at high (10 MHz) and low frequency (40 Hz) as a function of knuckle flexion angles;

FIG. 3(h) shows a R_{ac} versus R_{dc} map for different knuckle bending angle (circles) and pinching force (squares) at the fingertip using different frequencies (10 MHz, 5 MHz, 40 Hz);

FIG. 4(a) shows the simulated resistance from FEA simulations and the predicted resistances from a mathematical model as a function of stretching at different frequencies (DC, 10 MHz, 50 MHz);

FIG. 4(b) illustrates a Wheatstone bridge circuit incorporating the liquid metal sensor as Rₛₑₙₛₒᵣ;

FIG. 4(c) shows (i) an instrumentation amplifier used to collect differential voltage measurements of the liquid metal sensor and the calculated (ii) signal-to-noise ratio (SNR) versus power consumption from bias current of the Wheatstone bridge at different excitation frequencies (DC, 2 MHz, 10 MHz);

FIG. 5 shows correspondence of a mathematical model of AC resistance due to skin effect with the simulation value due to compression of a LM sensor, wherein a progressive increase in ratio denotes higher compression;

FIG. 6(a) shows an isometric 3D rendering of spiral inductor formed from liquid metal Litz wire stranded conductors;

FIG. 6(b) shows a cross section view of Litz wire strands formed from hollow channels;

FIG. 6(c) shows a FEA simulation predicted current density for solid cross-section wire showing proximity effect induced current crowding with a peak quality factor of 14;

FIG. 6(d) shows a FEA simulation showing lower current crowding effects due to stranded Litz wire structure with peak quality factor of 33;

FIG. 7(a) shows an experimentally measured quality factor versus frequency for liquid metal multistrand (Litz) wire versus liquid metal single strand spiral inductor from 1 kHz to 100 MHz with an inset showing high frequency RF measurement of prototype spiral inductor structure formed via filling of 3D printed channels;

FIG. 7(b) shows a quality factor versus frequency after normalizing by dividing by the mass of the liquid eutectic GaIn used in both designs; and

FIG. 8 shows an isometric rendering of liquid metal Litz wire inductor (i) fabricated using microchannels defined in a 3D printed part with woven individual parallel strands shown in (ii), wherein (iii) shows a prototype of this structure fabricated using microstereolithograpy and filled with liquid metal (EGaIn) (scale bar is 5 mm in length).

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Stretchable electronics have the advantage of matching the complex geometries and compliant tissues of the human body, which provides new opportunities for real-time biomechanical sensing. Embodiments disclosed herein use high frequency AC-enhanced resistive mechanical sensing that leverages the deformability of liquid metals to enhance low-power detection of mechanical stimuli in wearable electronics. The mechanism for this enhancement is the geometrical modulation of the AC skin effect, which induces current crowding at the surface of a liquid metal trace. This method can be applied in combination with DC sensing to quantitatively pinpoint varying mechanical modes of deformation such as stretching and compression that are otherwise difficult to distinguish by traditional methods. This innovative approach can drive a new generation of low-power wearable RF systems for haptics and biomedical sensing.

Understanding the electrodynamics of AC conduction in liquid metal conductors can help design sophisticated stretchable analog circuits for sensing and communication. Specifically, high-density stretchable electronics with passive components such as resistors, capacitors, vias, etc., made from liquid metal through soft lithography can benefit from the response of high frequency AC resistance to mechanical deformation. Liquid metals also can provide improved performance for applications such as wireless power transfer that are highly sensitive to resistive losses.

AC-based resistive sensing can use the AC skin-effect in deformable liquid metal conductors. This method can be used to enhance the sensitivity of liquid metal mechanical sensors to both stretching and compression modes of deformation and to understand the origins of enhanced sensitivity with finite element electromagnetic (EM) simulations. AC resistive sensing was demonstrated in a wearable, haptic glove device, illustrating multimodal detection of both stretching and compression.

Sensitivity can be enhanced and multiple simultaneous deformation modes of stretchable mechanical sensors using liquid metals can be distinguished. Detection of tensile strain oriented axially along the direction of current conduction and detection of compressive strain applied out of the plane of current conduction. The enhancement of these sensing functions uses an AC measurement approach that measures the resistance spectroscopically at medium (e.g., kHz) and high (e.g. MHz-GHz) frequencies.

Measuring geometrical modulation of an AC skin effect can include collecting a measurement of individual frequency points or a spectrum of resistances across a wide range of frequencies, interpreting the resistance spectrum, and inferring the type of strain and degree of strain. This information can be interpreted using machine learning methods such as convolutional or recurrent neural networks. Heuristics can be used to interpret spectral resistance data.

The AC sensing technique can work with different aspect ratios over a wide range. For liquid metals embedded in soft materials (e.g., hydrogels or soft elastomers), the sensitivity may be maximized by using a higher aspect ratio liquid metal trace which has a rectangular cross-section with a large ratio between the length and width. For liquid metals in harder polymers (e.g., stiffer elastomers, PVC, vinyl, PEEK, etc.), the sensitivity may be maximized by using a low aspect ratio cross-sectional geometry such as a square or circular cross-section. The encasing polymer can stretch or can deform without changing the perimeter of the liquid metal trace cross section. A soft elastomer or hydrogel can allow the liquid metal trace to grow in width, increasing the surface area available for skin effect limited conduction. A stiffer polymer will not stretch, so the perimeter of the liquid metal trace cross section is fixed and the change in AC resistance instead comes from the change from circular to elliptical cross-section shape. Thus, the technique can be optimized depending on the polymer or other soft material that the liquid metal is embedded within.

The technique disclosed herein can work for networks of liquid metal traces, such as an array or grid of liquid metal traces. The voltages can be sensed at multiple points across the array to map mechanical deformations such as compression or stretching. In an instance, the points across the array are at regular intervals. In another instance, the points are positioned to have a higher density in one area versus another area to provide more data points in the higher density area.

Embodiments disclosed herein can be used in flexible electronic systems, such as wearable sensors for biomedical applications (e.g., pulse wave systems, respiratory sensing, or biomechanical sensing for gate and mobility). Embodiments disclosed herein also can be used in haptic systems that sense user motion and deliver stimuli (e.g., tactile sensations). RF-enhanced sensing can distinguish user motion, such as the extension of a finger or pressure on a finger time. Embodiments disclosed herein can also be used in communication circuits and structures for wireless power transmission in flexible electronics.

In an embodiment, a system includes a liquid metal sensor including at least one trace. The trace can have a diameter from 1 μm to 10 cm (e.g., 0.1 mm to 1.5 mm). The liquid metal sensor can include a gallium-indium alloy, InGaSn, an alloy of gallium, indium, and bismuth, or an alloy of gallium, indium, and cadmium. The trace can be embedded in a soft material or polymer.

In an embodiment, the liquid metal sensor has a coaxial configuration having a tube within another tube. The liquid metal is included in both a core as well as a sheath layer. This configuration can reduce electromagnetic interference and minimizes stray inductance for improving high frequency measurements.

The liquid metal sensor may include a layered structure with a core and shell, both of which might have thicknesses from the tens of microns to 1-10 mm.

The materials of the polymer or elastomer for the tubing may have a Poisson ratio from 0 to 0.5. A larger or negative Poisson ratio material may be used.

The at least one trace can be part of a network of liquid metal traces (e.g., an array or grid). The trace can include parallel strands woven together, which is discussed in Example 2.

The system and sub-systems therein can include a personal computer system, image computer, mainframe computer system, workstation, network appliance, internet appliance, or other device. The sub-system(s) or system(s) may also include any suitable processor known in the art, such as a parallel processor. In addition, the sub-system(s) or system(s) may include a platform with high speed processing and software, either as a standalone or a networked tool. The processor can, for example, run a machine learning algorithm or other software for the sensing techniques. The processor can be in electronic communication with the liquid metal sensor.

For example, the processor can be configured to perform AC-based resistive sensing of the liquid metal sensor. The processor can also be configured to measure geometrical modulation of an AC skin effect in the trace of the liquid metal sensor, which may be used when current flow is predominantly confined to a surface of the trace. High-frequency AC resistance can be measured across different frequencies. The measurement can use a current source to deliver a bias current at each frequency and then record the relative phase and amplitude of the voltage signal appearing across the sensing element (i.e., the impedance).

The processor can be further configured to perform DC-based resistive sensing. DC-based resistive sensing can operate similar to AC-based resistive sensing, but using DC. DC-based resistive sensing can be used with the AC-based resistive sensing. For example, determining stretching versus compression of a sensor element can benefit from multiple frequencies as well as DC signals. This can enable quantification of the two modes of mechanical deformation.

The processor can be configured to detect tensile strain oriented axially along a direction of current conduction. There may be a regression analysis or another fitting method to provide a model linking tensile strain to resistance. This can be calibrated by initial measurements for a given device geometry and frequency. Tensile strain in the liquid metal fiber may result in an elongation along its axis, which is easily measurable by the change its length. The electrodes for applying current can be located on either end of the liquid metal fiber.

The processor can be configured to detect compressive strain applied out of a plane of current conduction. Similar to axial strain, the resistance can be linked to the level of compressive strain via a compact regression model. This can enable detection of the change in resistance for a level of strain that corresponds to a circular versus elliptical cross-section. Additional regression models can combine the effect of both the axial tensile strain and the compressive strain applied out of plane.

In some embodiments, various steps, functions, and/or operations of system and the sub-systems therein and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on a carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor (or computer system) or, alternatively, multiple processors (or multiple computer systems). Moreover, different sub-systems of the system may include one or more computing or logic systems. Therefore, the above description should not be interpreted as a limitation on the present disclosure but merely as an illustration.

High frequencies can induce higher resistance due to the AC skin effect in liquid metals, which confines current flow to the surface of metal conductors. The high frequencies can be, for example, from 100 kHz to 10 GHz. The upper limit of the high frequencies may be bounded by the circuits or integrated circuits that interface with the sensors. This overall increase has circuit-level benefits for reading out sensor data for liquid metal conductive sensors. The AC skin effect can enhance the sensitivity to changes in conductor geometry at high frequencies because the flow of current occurs at the surface, which can be modulated by mechanical deformation.

The size of the features can be adjusted to provide maximum sensitivity. For example, very high frequencies (GHz) may provide additional sensitivity if the traces are at the single micron scale for their diameters. Lower frequencies may provide higher sensitivity for the case of thicker mm-scale diameter liquid metal fibers.

The liquid metal sensor can include the liquid metal enclosed in the elastomer or other polymer. The liquid metal fiber also may have terminations that connect to the rest of the instrumentation circuit, for example, a precision current source (AC and/or DC) and a low noise amplifier for voltage measurements.

The AC resistance is sensitive to changes in the perimeter of the liquid metal conductor cross-section. Because of this sensitivity, the AC resistance may be preferentially sensitive to stretching rather than compression. The DC resistance is sensitive to both modes of deformation. An index of both AC and DC resistance allows simultaneous extraction of the stretching and compression of a single sensing element.

Disclosed herein are geometries and AC frequencies for enhancing the response (gauge factor) of liquid metal strain sensors and liquid metal pressure sensors. The circuit layout can be configured to maximize the sensitivity enhancement from these mechanisms. Planar geometries could include traces with targeted sensor regions that have a smaller cross-sectional area. These areas can have elevated sensitivity to stretching or compressive mechanical deformation. This principle could also be applied to cylindrical transmission line geometries, for which zones of finer gauge can provide elevated sensitivity to pressure or stretching deformation.

Many target areas can be sensed on a single liquid metal transmission line using multiplexing. Multifrequency sensing allows targeting of multiple regions with variable geometry because the frequency tunes the geometric sensitivity. This can be used to sense many deformable elements with a single set of electric terminals, which is often a design used with mobile and internet of things (IoT) applications with limited size, limited power, and pin count constraints.

The impact of deformation also can be minimized on a given instrumentation circuit realized from liquid metal. The disclosed geometrical design can provide a framework for minimizing changes in the trace impedance at a given frequency when exposed to compressive or stretching mode deformation.

Resistive sensing with both the high frequency and DC signals also can be applied to composites of liquid metals. Such microcomposites or nanocomposites have inclusions of liquid metal in a matrix of polymeric materials. The structure of the microcomposites or nanocomposites can affect the electronic strain response.

Skin effect can be used to enhance and differentiate modes of deformation to a liquid metal transmission line. This is helpful when using DC sensing applied to wearable electronic devices which has both transmission lines and sensing elements with changing electronic properties. Motion artifacts from use typically occur because of the stretchable properties of the materials. The ability to isolate one mode of deformation can improve devices, such as haptic systems, that precisely track motion and tactile interactions while delivering mechanical stimuli to a user.

High frequency AC and low frequency AC resistance for a liquid metal conductor tend to be sensitive to different changes in the conductive element geometry. High frequency AC resistance changes strongly with modulation of the surface area of the conductive element. Low frequency resistance is more sensitive to changes in the cross-sectional area of the conductive element.

At high frequencies (MHz-GHz), liquid metals exhibit the AC skin effect, as internal eddy currents force the majority of current to flow near the conductor's surface. The current density decays exponentially from the surface according to an effective depth skin depth (δ) given by the resistivity (ρ), radial frequency (ω) (which can be based on π and frequency (f)), and magnetic permeability (μ).

$$δ = \sqrt{\frac{ρ}{π \cdot f \cdot μ}}$$

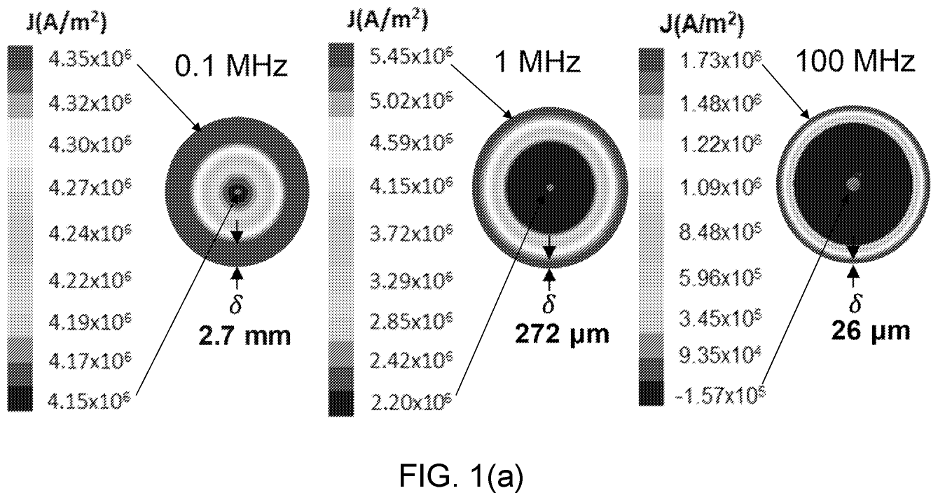

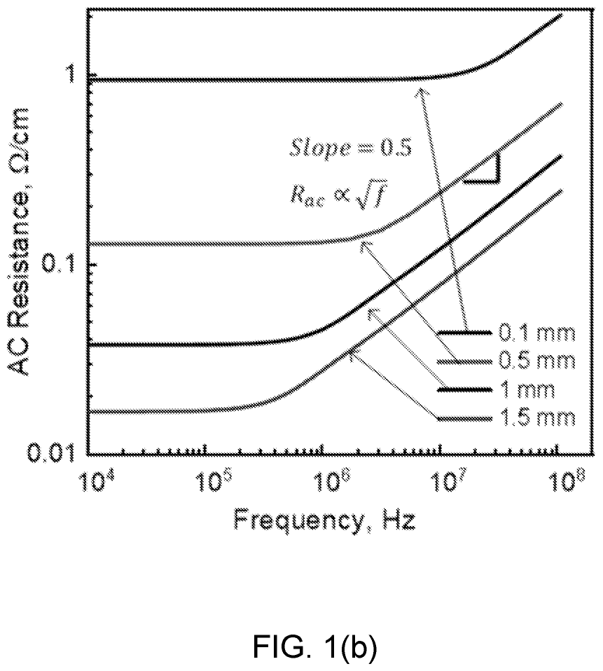

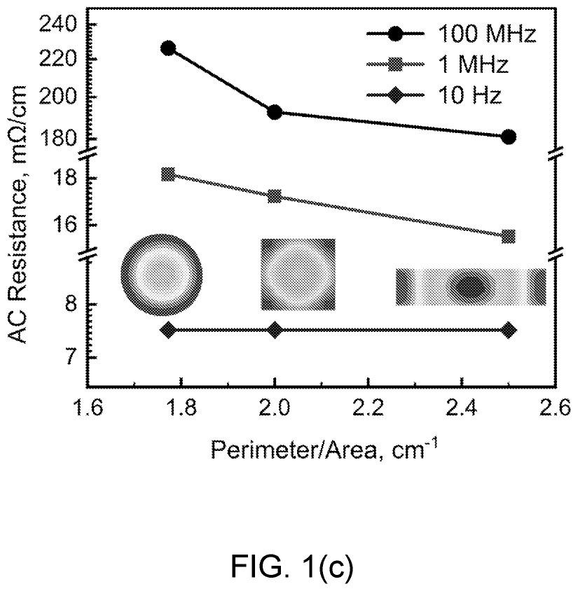

The skin depth scales inversely with the conductivity of the metal, leading to a larger skin depth in Ga-based liquid metals due to their higher bulk resistivity as compared to more conductive metals such as copper. Because the skin depth scales inversely with frequency, the main impact is that it increases the effective resistance of metals for AC signal conduction by leading to current crowding at the surface. Liquid metal conductors assembled by printing or dispensing methods with dimensions in the range from 100's m to 1 mm produces the onset of an increase in resistance at a range from 100's kHz to MHz. At this point, the skin depth becomes considerably smaller than the diameter of the conductor. FIG. 1(a) illustrates the difference in the current density between DC, medium frequency, and high frequency signals, showing the current crowding at high frequencies and the evenly distributed current density at low frequencies.

FIG. 1(b) shows the measured resistance versus frequency for liquid metal conductors of multiple diameters, illustrating how the AC skin effect enlarges the effective resistance at high frequencies. At a given frequency, the ratio of AC to DC resistance is amplified for the thicker liquid metal traces that have mm-scale diameters, leading to an AC resistance that scales with ω^{1/2} and can reach 10-100× of its DC value at 100 MHz. The larger diameter traces display the onset of the rise in the resistance at a lower frequency. The onset frequency of the skin-effect-induced increase in resistance depends on the device geometry. This can be used to determine whether the skin effect phenomenon adds to the resistance of the proposed AC devices and limits the Q factor for liquid metal devices such as an antenna used for wireless power transfer.

A geometrical consideration determining AC resistance from the skin effect is the ratio of the perimeter (“skin”) to the cross-sectional area. This is because the skin effect depends on the interplay between the perimeter and the area of the cross-section of the current-carrying conductor. FIG. 1(c) shows the trend of AC resistance for both the cross-section shape and the frequency. The simulated AC resistance is plotted for three different cross-sectional geometries including a circle, square and rectangle with the same nominal area of 4 mm², but varying perimeter. The circle has the lowest perimeter to area ratio, and the flatter rectangular cross-section has the highest perimeter. FIG. 1(c) shows how, at high frequencies, the skin effect results in decreased AC resistance for conductors with a higher perimeter to area ratio, and while at low frequencies (˜DC), the resistance is equivalent for all conductor shapes. The general implication of surface current crowding is that a conductor's cross-sectional shape will uniquely modulate the AC resistance and, therefore, provide additional sensitivity to mechanical deformation in the case of liquid metals. This can be used to enhance resistive sensing beyond the limits of DC transduction.

FIG. 1(d) shows an example of a flexible circuit including passive structures made from liquid metal, such as a spiral inductor and a serpentine patterned strain gauge. In the theoretical case of the spiral inductor, it is desirable to design for as low as possible an AC resistance to minimize losses and minimize its sensitivity to deformation for maintaining a tuned resonance (e.g., in wireless power transfer). However, for a strain gauge type mechanical sensor, the goal is to maximize sensitivity to mechanical deformation to improve sensitivity. Embodiments disclosed herein utilize AC excitation to amplify the sensitivity of liquid metal-based mechanical sensors.

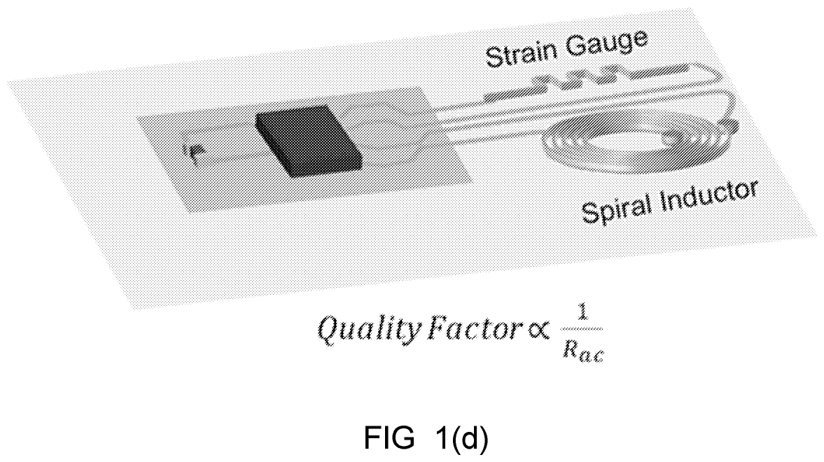

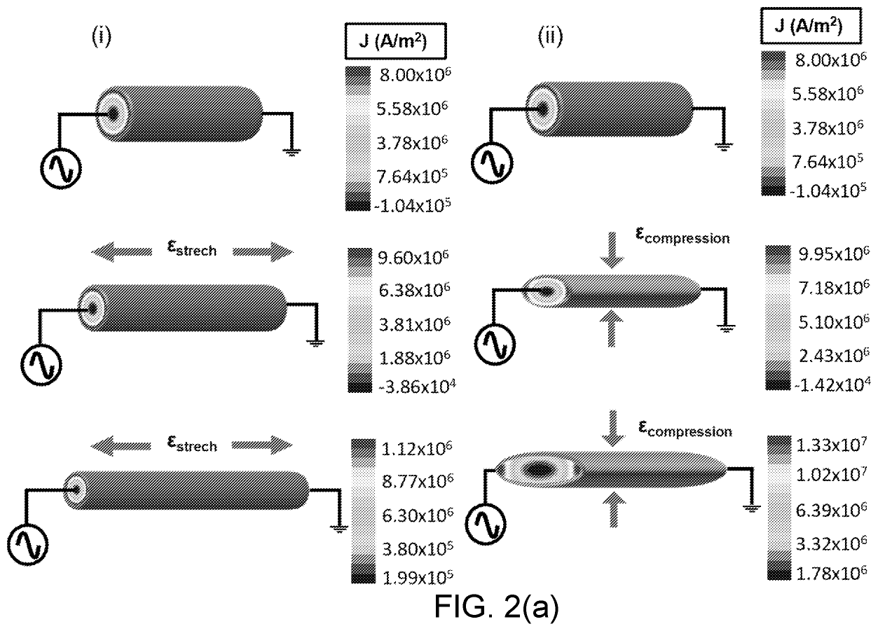

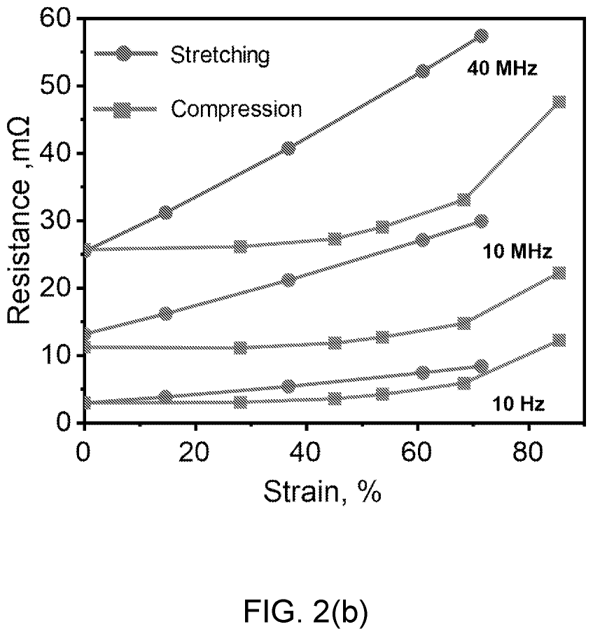

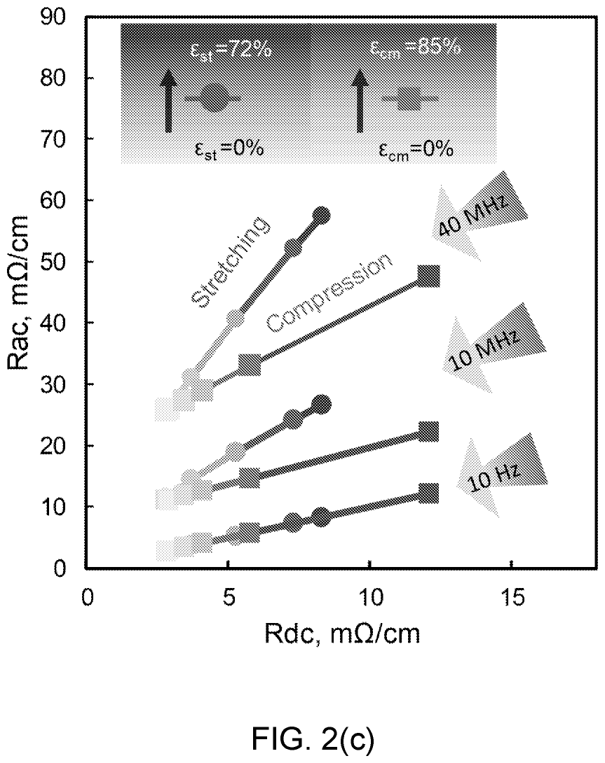

A model system for investigating the physics of AC resistive sensing was a stretchable liquid metal wire encased in a compliant elastomeric tubing (PDMS). As the liquid metal-filled silicone tubes are mechanically deformed, the perimeter to area ratio varies with the two primary modes: pinching or stretching. As shown in FIG. 2(a), this leads to distinct AC current density profiles predicted by 2D FEA simulations. These maps show how deformation of liquid metals into non-circular flatter elliptical cross-sections forces current density onto the ends of the ellipse, while stretching deformation (bottom) changes the effective diameter of the cross-section relative to the skin depth. With increasing compression, the perimeter to area ratio of the elliptical cross-section increases as the liquid metal is displaced. Along the major axis of the ellipse, the current crowds densely at the end-lobes, which leads to a severe non-symmetric skin effect as opposed to having a symmetrical current crowding in stretching modes. For instance, the peak current density (1.1·10⁷ A/m²) of the highly compressed elliptical cross-section is 3.5 times higher than the current density of the circular cross-section (8·10⁶ A/m²). However, due to the asymmetry in the geometry-increased perimeter to the area ratio for a flatter elliptical trace, the opposing eddy current at the center of a trace is weaker to the incoming input current than a symmetric cross-section akin to a circle. For example, as shown in the current maps in FIG. 2(a), the current density (1.9·10⁵ A/m²) at the center of the cross-section for a highly stretched (70%) trace is approximately 10 times lower than the case of a highly compressed liquid metal trace (1.78·10⁶ A m²), denoting a weaker opposing current for compressed trace than a stretched case at the center. This results in more utilization of the center of a trace for carrying AC, making the trace less resistive. As a result, the R_{ac} change in a compressed trace is much less intense than the stretched trace. In summary, mechanical strain modulates the AC resistance spectrum by modifying the current distribution, as shown in FIG. 2(a), which can serve as a basis for transducing these mechanical strains at high frequencies.

Unlike DC sensing, AC resistive sensing provides sufficient information to sense multimodal mechanical deformation, distinguishing between forces applied in an orthogonal (compression) or parallel (stretching) axis to the direction of current flow. FIG. 2(b) illustrates the response of AC and DC resistance of a given liquid metal conductor to increasing degrees of stretching and compression deformation, as predicted by FEA simulations for excitation at 10 Hz, 10 MHz, 40 MHz. The simulated response includes circular cross-sections with radius r₀ compressed to a series of ellipses with increasing compression in minor axis, b. An effective compression percentage can be calculated by normalizing the change in the minor axis by the initial radius

$$( \frac{\vert b - {r}_{0} \vert}{{r}_{0}} \times 100 \% ) .$$

This example explored compression from 0% to 84%, corresponding to eccentricity of 0 to 0.95. The simulated liquid metal trace is stretched along the length from 0 to 71.6% strain. With increasing strain, AC and DC resistance increase concurrently, as expected from the reduced cross-sectional area upon stretching and compression. However, at high frequencies (10 MHz and 40 MHz), the change of R_{ac} due to stretching is much steeper than the change due to compression, which results from the elongated cross-section induced by compression.

FIG. 2(c) displays a plot of R_{ac} versus R_{dc} for both increasing stretching and compression (with higher values of strain denoted by darker symbols) for different frequencies (10 Hz, 10 MHz, 40 MHz). The advantage of using this mapping to a combination of R_{dc} and R_{ac} for respective deformation modes is that it can distinguish the ratio between AC and DC resistance for stretching and compression, visible on FIG. 2(c) as two non-intersecting lines. This distinguishability facilitates the process of tracking the degree and nature of the deformation of the sensor with accuracy while interfacing with readout circuitry. As seen from FIG. 2(c), in compression, the ratio of changes in R_{ac} to R_{dc} is weaker than the change due to current crowding in the stretching mode. For example, at 10 MHz, the slope of the line representing the change of R_{ac} to R_{dc} for compression is 2.3× lower than stretching for the same nominal amount of strain. This variation of R_{ac} as a ratio to R_{dc} between stretching and compression is even more pronounced (2.5X higher) at 40 MHz, showing how high frequencies can progressively separate the modes. At low frequencies (10 Hz), R_{ac} and R_{dc} are both similar for stretching and compression, overlapping in the 2D R_{ac}/R_{dc} space. This means that DC transduction alone cannot distinguish between one deformation mode and another, for example, whether the ΔR₀ has resulted from a 20% stretch or a 15% compression. Using both AC resistance and DC resistance provides a sensitivity feature that allows for quantitative identification of the modes and degree of deformation.

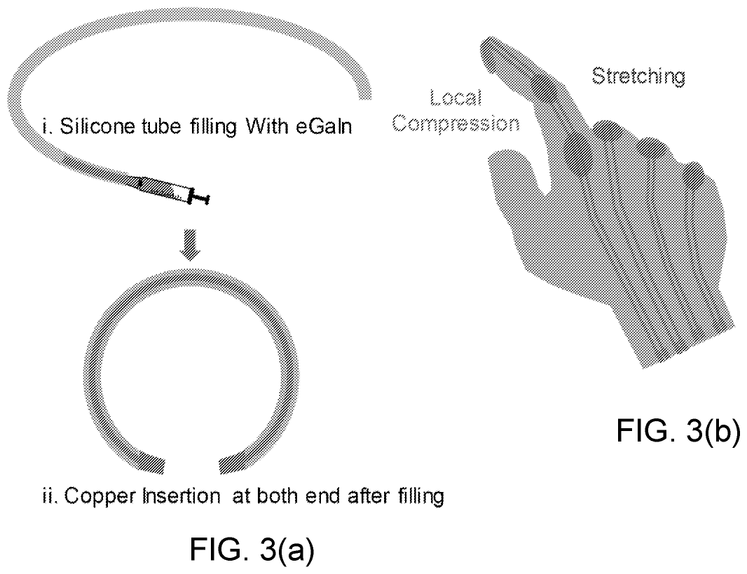

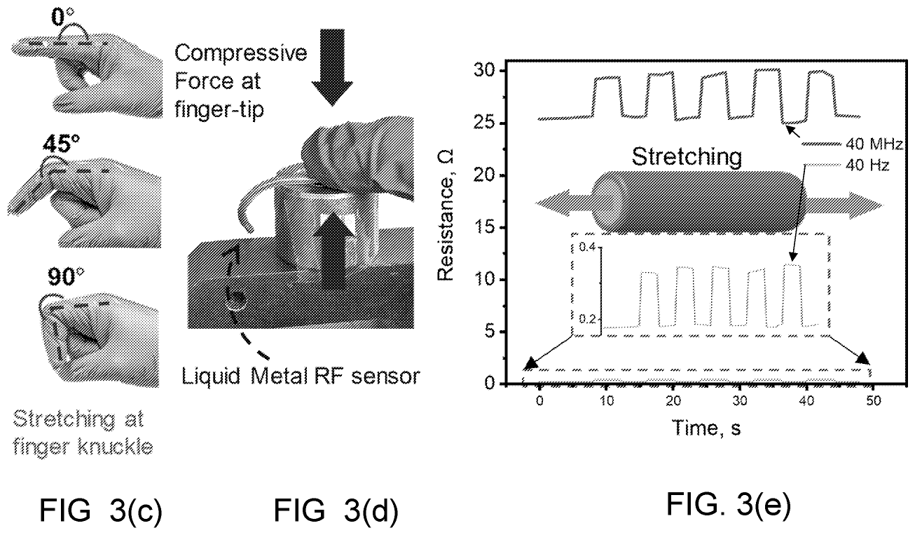

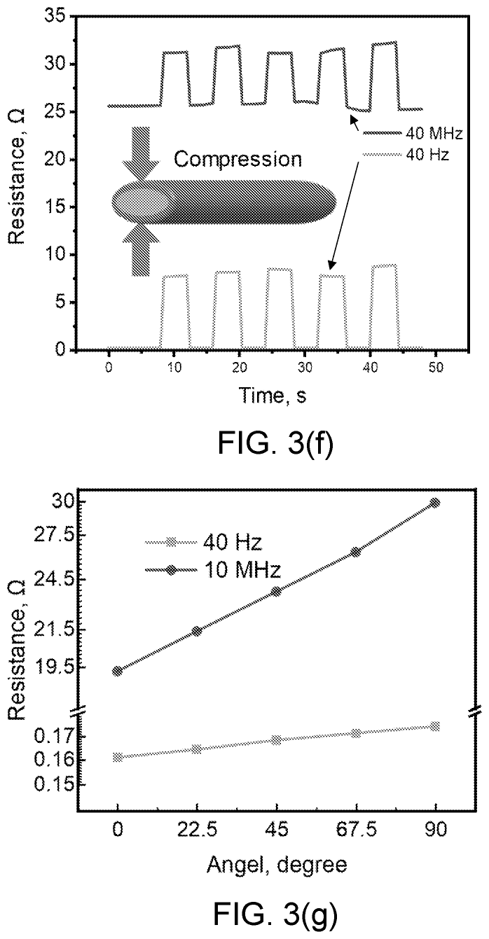

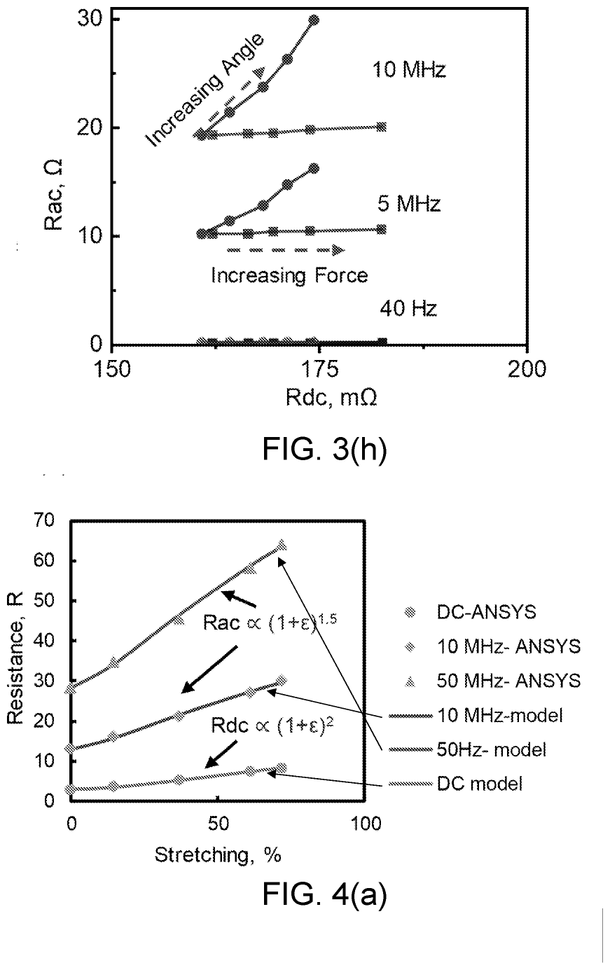

The AC-enhanced liquid metal sensor was fabricated and mounted on a glove to track various hand gestures. This fabrication method starts with filling a 10 cm long bare PDMS tube with an inner diameter of 0.5 mm diameter with eGaIn and is followed by sealing the ends of the tube with copper termination. The fabrication method is exhibited in FIG. 3(a). FIG. 3(b) displays a gesture tracking glove with strategically placed liquid metal sensors to track the knuckle joint's stretching and pinching on fingertips. This sensing modality is well suited to implementation in wearable haptic systems because it allows a single liquid metal sensing element to detect multiple deformation modes, simplifying the design of a wearable circuit. FIG. 3(c) depicts the stretching mode deformation of the liquid metal sensor through the flexion at the second knuckles index finger to multiple angles. FIG. 3(d) shows the compression mode due to force stemming from the fingertip against a loadcell of the force sensing system. FIGS. 3(e) and 3(f) demonstrate the liquid metal trace's AC and DC resistance during knuckle flexion and compression. As expected, progressively greater flexion or compressive force increases both the AC and DC resistance. FIGS. 3(e) and 3(f) also illustrates multiple cycles of flexion and compression via pinching to show the modulation of both AC and DC resistance over time, displaying the sensor's reversible electromechanical nature. FIG. 3(g) demonstrates the ability of this LM-based RF sensor to quantitatively sense gestures through measurement of knuckle flexion (from 0° to 90°). At progressively higher flexing angles, the stretching strain increases at the joint, which is reflected in the AC resistance at 10 MHz to a greater degree than at DC, illustrating the increased sensitivity achieved by utilizing the skin effect.

While eGaIn is disclosed, the sensor can use another gallium-indium alloy, InGaSn, an alloy of gallium, indium, and bismuth, or an alloy of gallium, indium, and cadmium. Other materials are possible.

The AC-enhanced liquid metal sensor can distinguish between the varying force of touch or degree of finger flexion experimentally through a high frequency excitation, as supported by the FEA simulation. Simultaneous measurement of both AC and DC resistance provides the ability to distinguish gestures, as shown in FIG. 3(h). FIG. 3(h) shows a map of AC (5 and 10 MHz) and DC resistance measured for a single wearable liquid metal trace worn during bending and pressing gestures executed by the wearer's index finger. High frequency (5 and 10 MHz) resistance measurements reliably differentiate these two classes of gestures, while DC measurements provide overlapping data that is indistinguishable. This capability can provide multifunctionality for liquid metal wearable sensors, specifically aiding force-feedback haptic systems requiring monitoring of gestures and touch.

Another result of AC strain sensing is that it can directly translate to power savings and reduce complexity for flexible readout circuits. This can be important for wearable systems that pose limitations on power and speed, requiring high computational efficiency for performing onboard signal processing with a low-power microcontroller unit (MCU). The power-efficient capability of AC resistance-based sensors stems from two features: the fact that it has a more linear dependence with respect to strain and that it requires lower bias currents and delivers higher SNR. A simple analysis of DC resistance for a cylindrical geometry shows that the resistance scales with (1+ε)², where E is the longitudinal strain induced by stretching. AC resistance limited by the skin effect scales with (1+ε)^{1.5}, which can be derived by accounting for the current flow within one skin depth for AC signals in the same cylindrical geometry.

Stretching a liquid metal conductor from length l₁ to length l₂ causes a change in the DC resistance that can be modeled simply by considering the change in cross-sectional area for a given level of tensile strain, ε=Λl/l.

$${R}_{D C} = \frac{ρ \cdot l}{{π}_{1} {r}^{2}} = \frac{ρ {l}^{2}}{{v}_{o}}$$

$$\frac{{R}_{D {C}_{2}}}{{R}_{D {C}_{1}}} = {( \frac{{l}_{2}}{{l}_{1}} )}^{2} = {( \frac{{l}_{1} + Δ l}{{l}_{1}} )}^{2} = {( 1 + ε )}^{2}$$

However, this changes for AC resistance.

$$Effective Area = skin depth * circumference = δ * ( 2 \cdot π \cdot r )$$

$${R}_{A C} \approx \frac{ρ l}{( 2 \cdot π \cdot r ) δ}$$

$${R}_{A C} \approx \frac{ρ l}{( 2 π \sqrt{\frac{{v}_{0}}{π l}} ) δ}$$

$${R}_{A C} \approx \frac{ρ {l}^{3 / 2}}{( 2 π \sqrt{\frac{{v}_{0}}{π}} ) δ}$$

$$\frac{{R}_{A {c}_{2}}}{{R}_{A {c}_{1}}} \approx {( \frac{{l}_{2}}{{l}_{1}} )}^{3 / 2}$$

R_{DC1} is the DC resistance of the sensor before stretching, when the sensor has a length l₁. R_{DC2} is the DC resistance of the sensor after being stretched to a length, l₂, corresponding to a strain value of

$$ε = \frac{( l 2 - l 1 )}{l 1} - ( \frac{Δ l}{{l}_{1}} ) .$$

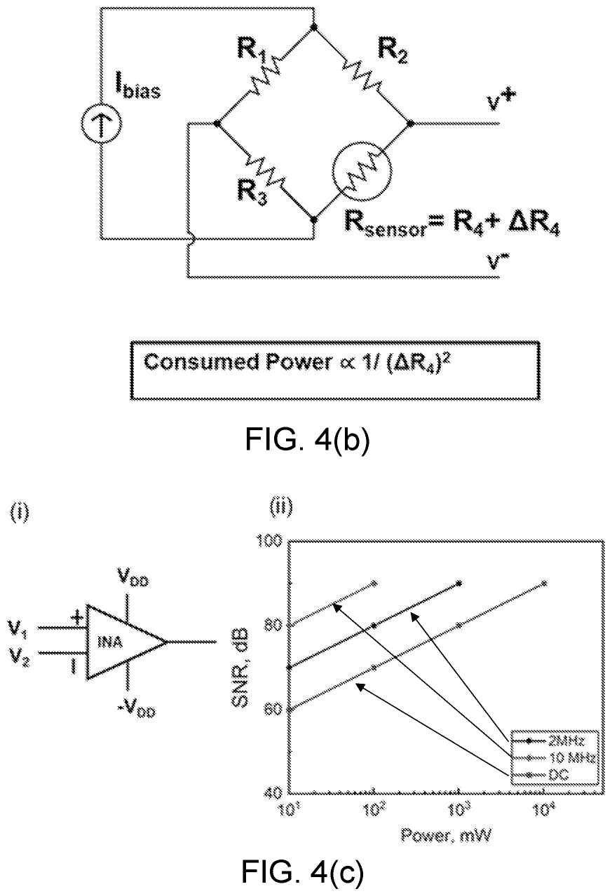

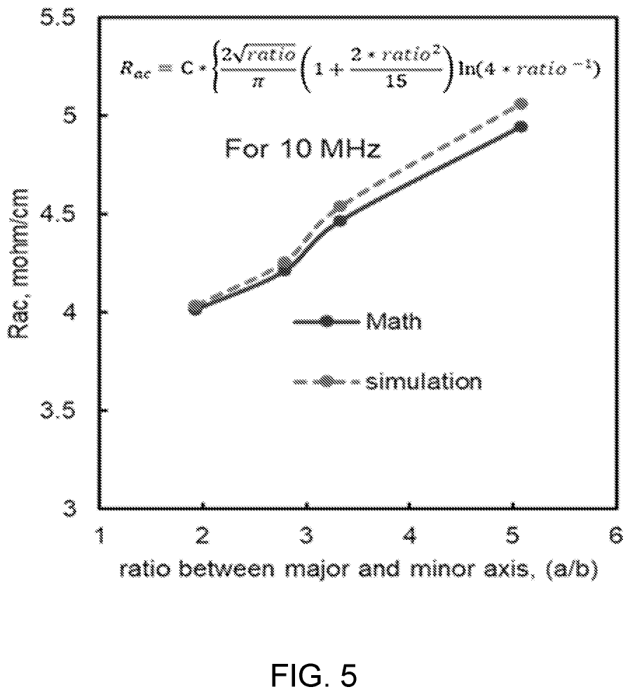

FIG. 4(a) depicts the simulated resistance versus strain as well as the regression model fits according to these scaling laws, showing the resistance change with strain at different frequencies (DC, 10 MHz, 50 MHz). For DC, a quadratic regression model with a dependence on (1+ε)² yields a tight fit with the simulated resistance values. This also means that the gauge factor itself is linearly changing with strain for DC resistive sensing, degrading the sensor linearity for sensing a given range of strains. For the high frequency resistance, the regression model fits the data well with a (1+ε)^{1.5} dependency and the trend shown in FIG. 4(a) illustrates the improved linearity of AC resistive sensing. In the case of compressive strain, a mathematical model found in literature fits the simulated R_{ac} properly with the changing ratio of the major to the minor axis, (a/b)—as a response to compression. FIG. 5 displays the fit between the R_{ac} from mathematical explicit equation and simulation, which show a linear dependency on the ln(a/b).

AC measurements are suited to high accuracy and low power detection because they can reduce pickup of random 1/f noise. The skin-effect enhanced AC resistance has the additional benefit of directly reducing the power consumption for a nominal LM strain sensor by increasing the nominal resistance. To illustrate this point, it is assumed that the sensor is connected in a common Wheatstone bridge configuration as one of the four arms with a resistance, R₄, as shown in FIG. 4(b). The differential voltage measured across the sensing resistance is generated by passing a sufficient bias current. This voltage must be substantially larger than the nominal noise voltage at the instrumentation amplifier's input terminals. This ratio can be considered a nominal SNR for a resistive sensing measurement.

The following equations describes the relation between power consumption (P_{consumption}), I_{bias}, and (ΔR) when implemented in a simple Wheatstone bridge with an equivalent nominal resistance R₁=R₂=R₃=R₄. Vₙ is the nominal input noise voltage of the amplifier circuit used for readout. V_{signal} is the differential voltage measured across the bridge circuit. P_{consumption} may be equivalent to P_{consumed}. I_{bias} is the bias current required for producing a measurable voltage across the sensor implemented in the bridge circuit. ΔR is the change in the resistance of the sensor compared to its nominal, unstrained value. V_{signal} is the voltage measured across the bridge circuit. Vₙ is the specified input noise voltage of the amplifier circuit.

$$20 \cdot {log}_{10} ( \frac{{v}_{signal}}{{v}_{N}} ) = SNR ( dB )$$

$$20 \cdot {log}_{10} ( \frac{{I}_{bias} * Δ R}{{v}_{N}} ) - SNR ( dB )$$

$${I}_{bias} \cdot Δ R = {v}_{N} \cdot {10}^{( \frac{SNR}{20 dB} )}$$

$${I}_{bias} = \frac{{v}_{N}}{Δ R} \cdot {10}^{( \frac{SNR}{20} )}$$

$$\sqrt{\frac{{P}_{consumed}}{{R}_{4}}} = \frac{{v}_{N}}{Δ R} \cdot {10}^{( \frac{SNR}{20 dB} )}$$

$${P}_{consumed} = \frac{{R}_{4}}{{( Δ R )}^{2}} \cdot {v}_{N}^{2} \cdot {10}^{\frac{SNR}{10 dB}}$$

Based on these assumptions, the scaling of SNR with power consumption from bias-current applied to the bridge circuit is plotted in FIG. 4(c). AC measurements are suited to high accuracy and low power detection because they can reduce pickup of random 1/f noise. The skin-effect enhanced AC resistance has the additional benefit of directly reducing the power consumption for a nominal LM strain sensor by increasing the nominal resistance. To illustrate this point, it is assumed that the sensor is connected in a common Wheatstone bridge configuration as one of the four arms with a resistance, R₄, as shown in FIG. 4(b). The differential voltage measured across the sensing resistance is generated by passing a sufficient bias current. This voltage must be substantially larger than the nominal noise voltage at the instrumentation amplifier's input terminals. This ratio can be considered a nominal signal-to-noise ratio (SNR) for a resistive sensing measurement.

AC-enhanced resistive mechanical sensing that leverages the deformability of liquid metals can be used to achieve low-power detection of mechanical stimuli in wearable electronics. Finite element simulations illustrate the mapping between the deformation of liquid metal conductors' cross-sectional geometry and their AC resistance. Experimental measurements confirm these results in the 50 Hz to 100 MHz range, illustrating how multiple modes of mechanical stimuli (compression or stretching) can be distinguished and quantified in a liquid metal trace acting as a sensor, matching a compact mathematical model to predict the resistance versus strain. A wearable device with the liquid metal sensor mounted on a glove provided a view of how AC-enhanced sensing can improve the power consumption and sensitivity of RF haptic electronic systems for future augmented or virtual reality devices. Other manifestations of eddy current, such as proximity effect (induction of eddy current in nearby conductors), can also be used to sensitively modulate the AC resistance. The strategic use of such device geometries and specific design for a given frequency range could even extend sensing functionalities for tactile sensing of touch, slip angle, and torsion.

In an embodiment, the method disclosed herein includes receiving measurements of geometrical modulation of an AC skin effect in a trace of a liquid metal sensor. Current flow may be predominantly confined to a surface of the trace. The trace may include an embodiment of a design disclosed herein.

AC-based resistive sensing on the measurements using a processor can be performed. DC-based resistive sensing using the processor, a mode and a degree of deformation of the trace, detecting tensile strain oriented axially along a direction of current conduction, and/or detecting compressive strain applied out of a plane of current conduction also can be determined or performed using the processor. A non-transitory computer readable medium storing a program can be configured to instruct a processor to execute an embodiment of the method disclosed herein.

The examples disclosed herein are merely possible implementations. These examples are not meant to be limiting.

### Example 1

The liquid metal sensors were fabricated by filling PDMS tubing with eGaIn via a needle-tipped syringe. The needle's inner diameter was selected to be slightly larger than the tube's diameter so that the PDMS tube tightly fit over the nozzle. This helped the liquid metal flow so that the meniscus of liquid metal encompassed the whole cross-section of the tube, leaving no air bubbles. Cylindrical copper wires inserted at both ends of the PDMS tube were used as rigid contact points for high frequency electrical measurements. The Cu wire diameter was selected to be approximately 50% larger than the PDMS diameter so that the PDMS tube was tightly wrapped around the metal at the junction of the copper wire and the PDMS tube. Adhesive (KG92548R) was placed to further seal the junction to prevent any liquid metal from leaking.

Finite element electromagnetic simulations were performed using the ANSYS Maxwell simulator package. The simulation was done on an LM-filled tube cross-section where 2D Maxwell equations were applied. The eddy current map and the related resistance value were calculated through the FEA solver. Different ranges of frequency points, from 10 Hz to 100 MHz, were performed for the eddy current analysis alongside their corresponding current maps. The simulations were done with a 0.1% error with 30 iterations and fine meshing.

With additional compressive strain, the cross-section tends towards a more elliptical shape. The values for the major and minor axis (a, b) were found from taking the cross-sectional images of compressively strained blank PDMS tubes. The PDMS tube was mounted on a load cell of the Pasco Materials Testing System (ME-8244), and vertical displacement of the load cell, which compressed the PDMS tube, was recorded through the PASCO interface. Cross-sectional images displayed a progressive trend in increasing the eccentricity of the ellipses with vertical displacement of the load cell. ImageJ was used to process the image to get the deformed tube's major and minor axis at each strain value. These changes of axis values were in accord with the displacement value from the PASCO's vertical displacement value. These axis values were used later to simulate the equivalent ellipse in the FEA simulator to mimic the compressive strain. To replicate the uniaxial stretching with an LM sensor in ANSYS, tubes were simulated with different diameters that reflected the length increment while stretching was performed.

AC impedance measurements were completed with an Agilent 4294A impedance analyzer. AC resistances were recorded from 40 Hz to 110 MHz. Open, short, and fixed resistance calibrations were performed for the entire frequency range. We specifically note that the AC resistance of the copper terminations was calibrated out while doing the short calibration. The PASCO mechanical measurement system was used concurrently during the AC electrical measurements to provide control over the compression of the sensor for a range of 0% to 85%, measured from compression of the minor axis value compared to the starting radius of the circle. In addition, a custom-built uniaxial stretching setup was created for the stretching test of the sensor from 0% to 70% strain.

### Example 2

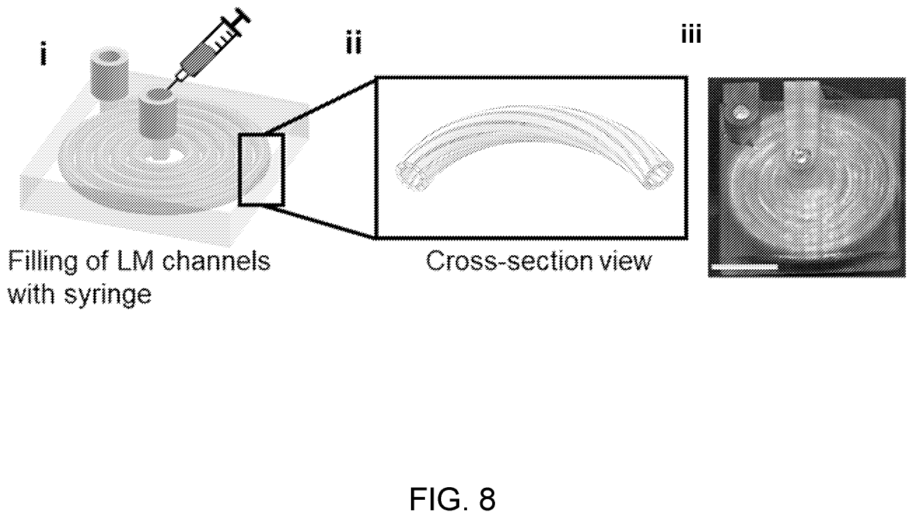

The AC resistance of liquid metal transmission lines can be minimized using multistranded conductor designs that take advantage of the AC skin effect. The parallel strands that make up the transmission line can be woven together in a spiral pattern similar to those used in traditional copper-based Litz wire (see FIG. 8). An advantage of this multiple stranded conductor geometry is that the AC resistance can be lowered because of the larger total surface area of the narrower strands compared with a thicker transmission line of similar cross-sectional area. High-frequency conduction is aided by the increased surface area and current can be more evenly distributed. The spiral arrangement of the multiple strands can be designed to minimize the increase in resistance caused by electromagnetic proximity effects that occur due to the magnetic field generated by loops of the transmission line in a structure such as a spiral inductor.

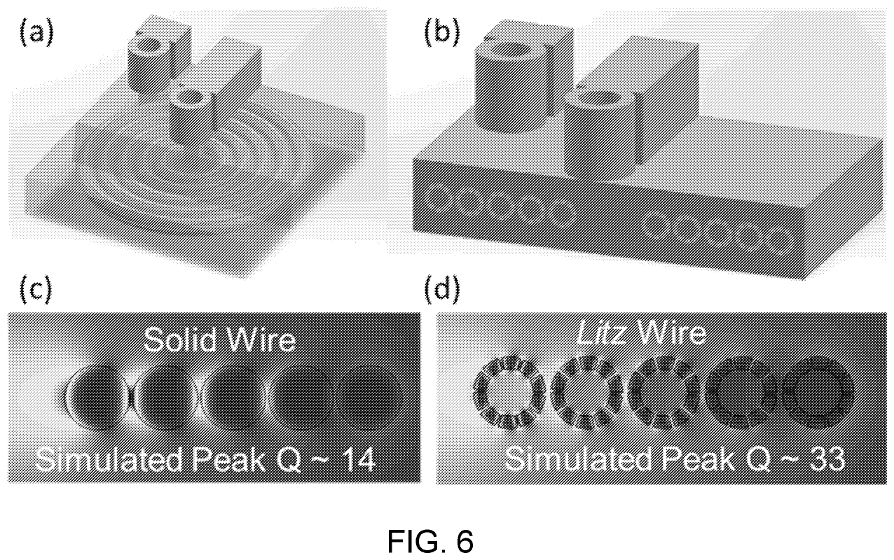

In an embodiment of a stranded designs, such as those shown in FIG. 6(a) and FIG. 6(b), minimizing the AC resistance of the transmission lines allows them to function as effective interconnects for circuits incorporating electrical components such as the sensors as described herein or antennas for communication and wireless power transfer. Prototype structures incorporating liquid metal-based Litz wire style transmission line geometries with strands in the range from 100 μm to 1 mm have been manufactured. Electromagnetic finite element simulations (Maxwell ANSYS) were used to compute the AC resistance of these structures at frequencies from 0.1 to 200 MHz and to map the current density (FIG. 6(c)) to identify the impact of proximity effects occurring between individual strands of liquid metal.

These conductors were designed with multiple cross-sectional geometries for the individual strands, including trapezoidal cross-sections arranged radially (FIG. 6(d)) and circular cross-sections arranged radially. Simulations indicate that these stranded transmission line geometries can lower the resistive losses in the MHz frequency range, leading to higher quality factor (Q) resonances in antenna structures. Finer Litz strands down to the 10 μm range may provide this benefit at frequencies greater than 100 MHz. These simulations focused on strands with diameters of approximately 200 m, leading to optimal quality factor at frequencies relevant to near field communication (NFC) standard frequencies (13.56 MHz). The predicted performance of the multiple stranded liquid metal Litz wire geometries was compared against liquid metal wires that fill the entire cross-section with metal. In one instance, the disclosed skin-effect optimized design of a circular spiral inductor resulted in a peak Q factor that is more than 100% greater for the stranded Litz wire structure (32.7) compared to a solid liquid metal wire (14.2). This enhancement to the resonance of these structures can improve performance in various communication and power transmission applications that also need flexibility or stretchability that could not be achieved with rigid copper wires.

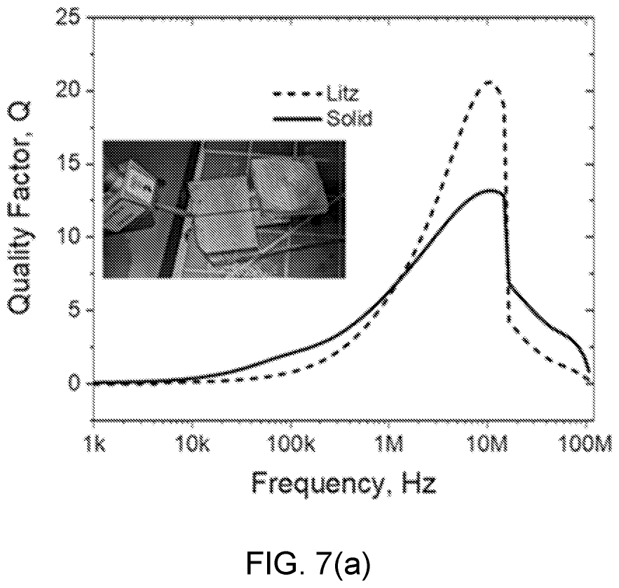

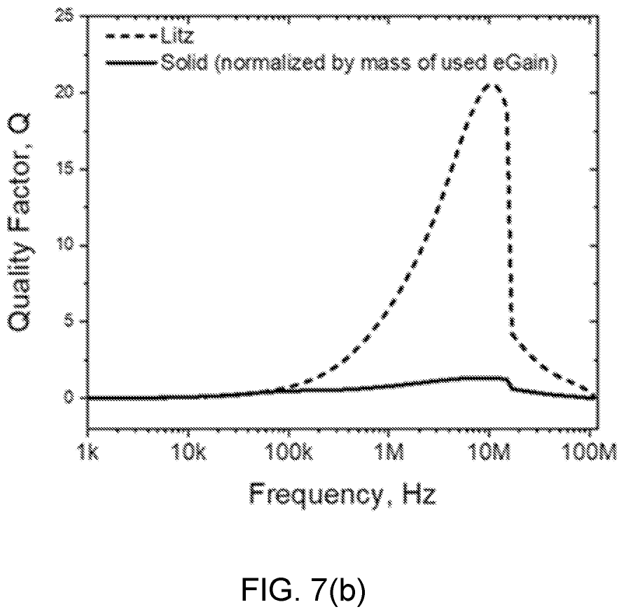

Prototype structures based on these designs were fabricated using microstereolithography, a 3D printing method for fabricating complex networks of microscale channels encased in a polymer. These microscale channels were filled with liquid metal to form the stranded conductor structures and their electrical properties were measured at frequencies from 1 kHz to 100 MHz. These experimental results confirmed that stranded conductors exhibit lower resistance leading to higher quality resonance. Embodiments with spiral inductor structures with five turns and a nominal inductance of 172 nH exhibited a peak Quality Factor of 20.6 for multi-strand liquid metal Litz wire versus 13.1 for a solid liquid metal single strand structure, as shown in FIG. 7. One impact from improving the quality factor of the designs such as these is the ability to enhance wireless power transfer to stretchable and wearable electronics. Higher quality factor coils can allow substantially increased wireless power transmission efficiency, especially under non-ideal conditions of low coupling coefficients, for example, due to coil misalignment or larger inter winding distances.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a liquid metal sensor including at least one trace; and
a processor in electronic communication with the liquid metal sensor, wherein the processor is configured to perform AC-based resistive sensing of the liquid metal sensor.

2. The system of claim 1, wherein the processor is configured to measure geometrical modulation of an AC skin effect in the trace of the liquid metal sensor.

3. The system of claim 2, wherein current flow is predominantly confined to a surface of the trace.

4. The system of claim 1, wherein the processor is further configured to perform DC-based resistive sensing.

5. The system of claim 1, wherein the processor is configured to detect tensile strain oriented axially along a direction of current conduction.

6. The system of claim 1, wherein the processor is configured to detect compressive strain applied out of a plane of current conduction.

7. The system of claim 1, wherein the trace has a diameter from 1 μm to 10 cm.

8. The system of claim 1, wherein the liquid metal sensor includes a gallium-indium alloy, InGaSn, an alloy of gallium, indium, and bismuth, or an alloy of gallium, indium, and cadmium.

9. The system of claim 1, wherein the at least one trace is part of a network of liquid metal traces.

10. The system of claim 1, wherein the trace includes parallel strands woven together.

11. A method comprising:
receiving measurements of geometrical modulation of an AC skin effect in a trace of a liquid metal sensor; and
performing AC-based resistive sensing on the measurements using a processor.

12. The method of claim 11, wherein current flow is predominantly confined to a surface of the trace.

13. The method of claim 11, further comprising performing DC-based resistive sensing using the processor.

14. The method of claim 13, further comprising determining a mode and a degree of deformation of the trace.

15. The method of claim 11, further comprising detecting tensile strain oriented axially along a direction of current conduction using the processor.

16. The method of claim 11, further comprising detecting compressive strain applied out of a plane of current conduction using the processor.

17. The method of claim 11, wherein the trace has a diameter from 1 μm to 10 cm.

18. The method of claim 11, wherein the liquid metal sensor includes a gallium-indium alloy, InGaSn, an alloy of gallium, indium, and bismuth, or an alloy of gallium, indium, and cadmium.

19. The method of claim 11, wherein the trace is part of a network of liquid metal traces.

20. A non-transitory computer readable medium storing a program configured to instruct a processor to execute the method of claim 11.
